(19) United States
(12) Patent Application Publication
(10) Pub. No.: US 2021/0286949 A1
(43) Pub. Date: Sep. 16, 2021

(54) DIALOGUE SYSTEM

(71) Applicant: NTT DOCOMO, INC., Chiyoda-ku (JP)

(72) Inventors: Takanori HASHIMOTO, Chiyoda-ku (JP); Yuriko OZAKI, Chiyoda-ku (JP); Hiroshi FUJIMOTO, Chiyoda-ku (JP)

(73) Assignee: NTT DOCOMO, INC., Chiyoda-ku (JP)

(21) Appl. No.: 16/338,750

(22) PCT Filed: Apr. 4, 2018
(86) PCT No.: PCT/JP2018/014439

§ 371 Date: Apr. 2, 2019

(30) Foreign Application Priority Data
Apr. 6, 2017 (JP) 2017-076062

(51) Int. Cl. G06F 40/30; G06F 16/245; G06F 3/0484

(52) U.S. Cl. CPC G06F 40/30; G06F 3/04842; G06F 16/245

(57) ABSTRACT

Provided is a dialogue system where appropriate dialogue is conducted for a user when acquiring a question sentence in FAQ or the like. A key question sentence generation unit extracts one key from an answer database based on an initial key and generates a key question sentence. An output unit transmits an ask-back sentence including the key question sentence containing the one key and one or a plurality of initial keys to a user terminal. The output unit further transmits the initial key as an acquired key used for extracting the one key to the user terminal. By such processing, dialogue processing is performed by key input and an ask-back sentence in response to the key input.

### TECHNICAL FIELD

The present invention relates to a dialogue system that provides an answer to a question sentence input by a user.

### BACKGROUND ART

An FAQ system that performs processing of replying an answer to a question by matching has been known. For example, The following Patent Literature 1 describes a technique that acquires a search query from a user, matches this search query against exemplary sentences prepared in advance, and thereby presents FAQ information.

### CITATION LIST

### Non Patent Literature

PTL1: Japanese Unexamined Patent Publication No. 2003-228575

### SUMMARY OF INVENTION

### Technical Problem

However, in the technique disclosed in the above-described Patent Literature 1, what keywords have been used to refine search is unknown to a user in some cases. This causes a user to have concern about whether dialogue is proceeding properly.

To solve the above problem, an object of the present invention is to provide a dialogue system capable of advancing dialogue without causing a user any concern when presenting a question sentence to the user in FAQ or the like.

### Solution to Problem

To solve the above problem, a dialogue system according to one aspect of the present invention is a dialogue system that provides an answer in response to input by a user, which includes an answer information storage unit configured to store answer information where a representative question sentence, a group of keys including one or a plurality of keys constituting the representative question sentence, and an answer to the representative question sentence are associated with one another, an initial key extraction unit configured to extract one or a plurality of initial keys based on an input sequence input by the user, a question sentence refinement unit configured to refine a representative question sentence stored in the answer information storage unit based on an initial key extracted by the initial key extraction unit, a key extraction unit configured to extract one key from the answer information storage unit based on the one or plurality of initial keys, and a presentation unit configured to present the one key and the one or plurality of initial keys to the user, wherein the presentation unit enables presenting, to a user, the one or plurality of initial keys as an acquired key used for acquiring the one key, and presents, to the user, a key question sentence prompting the user to clearly express an intention for the one key, the question sentence refinement unit refines the representative question sentence based on the user's intention expressed in response to the key question sentence, and the presentation unit presents, to the user, a representative question sentence refined by the question sentence refinement unit.

In this configuration, even when a user does not come up with a key for searching question sentences or remembers a wrong key, the dialogue system asks back for a key to the user, and the user can thereby gradually refine a question sentence. Further, by presenting an acquired key to the user, the user can grasp how an ask-back question is done. The user can thereby know what keys have been used to acquire a question sentence and use a FAQ service without any concern.

### Advantageous Effects of Invention

According to the present invention, a user can know what keys have been used to acquire a question sentence and use a FAQ service without any concern.

### BRIEF DESCRIPTION OF DRAWINGS

FIG. 1 is a block diagram showing the functional configuration of a dialogue system according to this embodiment.

FIG. 2 is a view showing a specific example of an answer database in which an answer to an inquiry candidate sentence, a key (word) and the viewing frequency are associated with one another.

FIG. 3 is a flowchart showing a process of a dialogue server 100 in a dialogue system.

FIG. 4 is a view schematically showing an answer database 112 and question sentence candidate information corresponding to each processing.

FIG. 5 is a view showing a display screen of a user terminal 200.

FIG. 6 is a view showing an alternative example of a display screen of the user terminal 200, which includes a dialogue screen M1 and an auxiliary screen M2.

FIG. 7 is a view showing an alternative example of a display screen of the user terminal 200, where the dialogue screen M1 includes answers corresponding to candidate question sentences.

FIG. 8 is a view showing a display screen when editing an acquired key.

FIG. 9 is a view showing a display screen that displays the number of remaining candidates.

FIG. 10 is a view showing the hardware configuration of the dialogue server 100.

### DESCRIPTION OF EMBODIMENTS

An embodiment of the present invention is described hereinafter with reference to the attached drawings. Note that, where possible, the same elements are denoted by the same reference symbols and redundant description thereof is omitted.

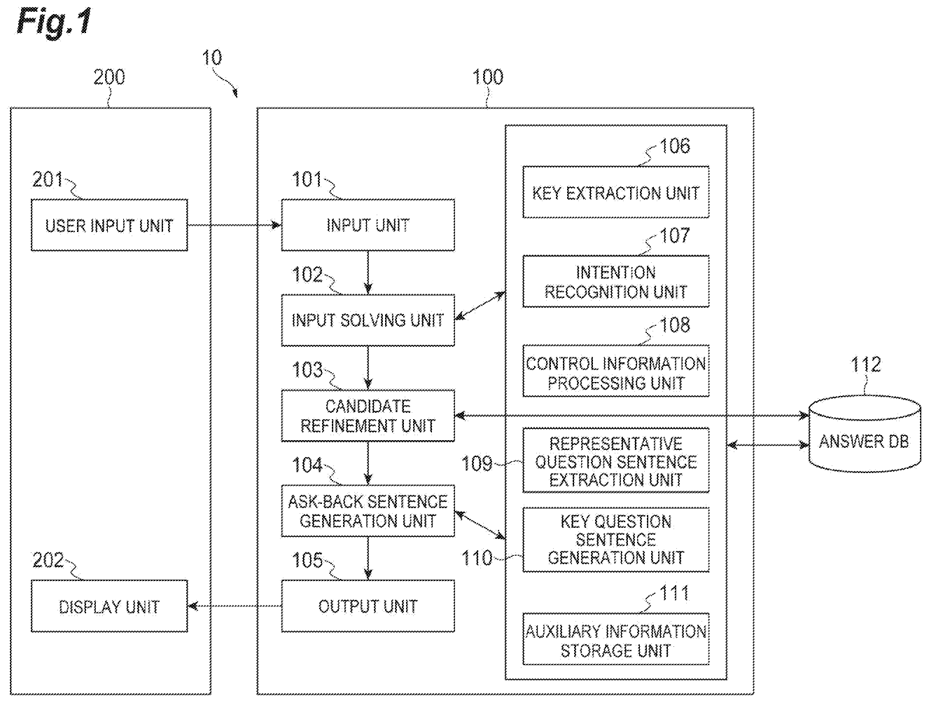

FIG. 1 is a block diagram showing the functional configuration of a dialogue system according to this embodiment. The dialogue system is composed of a dialogue server 100 and a user terminal 200. The user terminal 200 may include all functions of the dialogue server 100 and, in this case, the user terminal 200 serves as the dialogue system.

The dialogue server 100 includes an input unit 101, an input solving unit 102, a candidate refinement unit 103 (question sentence refinement unit), an ask-back sentence generation unit 104, an output unit 105 (presentation unit), a key extraction unit 106 (initial key extraction unit), an intention recognition unit 107, a control information processing unit 108 (skip processing unit, undo processing unit, clear processing unit, editing unit, presentation unit), a representative question sentence extraction unit 109, a key question sentence generation unit 110 (key extraction unit), an auxiliary information storage unit 111, and an answer database 112 (answer information storage unit). The user terminal 200 includes a user input unit 201 and a display unit 202, and the user input unit 201 receives an input sentence and transmits the input sentence to the dialogue server 100, and the display unit 202 receives and displays an ask-back sentence transmitted from the dialogue server 100. The functional configuration of the dialogue server 100 is described hereinafter.

The input unit 101 is a part that receives, through a network, an input sentence, intention information and control information input in the user terminal 200.

The input solving unit 102 is a part for solving an instruction for refining a representative question sentence in accordance with the input sentence, the intention information or the control information input by a user of the user terminal 200. The input solving unit 102 solves the refinement instruction transmitted from the user terminal 200 in cooperation with the key extraction unit 106, the intention recognition unit 107 and the control information processing unit 108.

The candidate refinement unit 103 is a part that refines one or a plurality of question sentence candidate information containing a representative question sentence and its answer stored in the answer database 112 based on a key (initial key or one key) solved and obtained in the input solving unit 102.

The ask-back sentence generation unit 104 is a part that generates an ask-back sentence containing a key question sentence and an acquired key, which is the content of output in response to input from the user terminal 200. The key question sentence is a sentence for asking a user a question about a key, such as the sentence “Is this a question about ∘∘?” for example. The acquired key is a key contained in an input sentence initially input by a user and a key used for a key question sentence. The ask-back sentence generation unit 104 generates the ask-back sentence in cooperation with the representative question sentence extraction unit 109, the key question sentence generation unit 110 and the auxiliary information storage unit 111.

The output unit 105 is a part that transmits, to the user terminal 200, the ask-back sentence generated by the ask-back sentence generation unit 104.

The key extraction unit 106 is a part that extracts an initial key, which is a word in each part of speech, by performing processing such as morphological analysis on an input sentence input by a user in accordance with the refinement instruction from the input solving unit 102. For example, for the input sentence “I cannot send email”, the key extraction unit 106 extracts “email” and “cannot send”. The candidate refinement unit 103 receives the initial keys extracted by the key extraction unit 106 and extracts question sentence candidate information based on those initial keys.

The intention recognition unit 107 is a part that, when the input solving unit 102 receives intention information (which indicates affirmation or negation), which is an instruction in response to a key question sentence to be answered with an affirmative or negative response, recognizes its intention. When the intention recognition unit 107 receives the intention information indicating affirmation, it stores the keys contained in the key question sentence as the acquired key into the auxiliary information storage unit 111.

The control information processing unit 108 is a part that, when the input solving unit 102 receives control information to cause any one of skipping an ask-back sentence (skip processing), returning to the immediately previous ask-back sentence (undo processing) and clearing the acquired key contained in the previous ask-back sentences (clear processing), performs the specified one of those processing. Further, the control information processing unit 108 performs processing on various control information such as replacement of a related key or deletion of an acquired key by a user operation.

The representative question sentence extraction unit 109 is a part that, when the ask-back sentence generation unit 104 determines that the number of refined question sentence candidate information is less than a specified value, extracts one or a plurality of representative question sentences as a refinement result from the answer database 112. The output unit 105 transmits one or a plurality of representative question sentences extracted by the representative question sentence extraction unit 109 to the user terminal 200.

The key question sentence generation unit 110 is a part that, when the ask-back sentence generation unit 104 determines that the number of refined question sentence candidate information is equal to or more than a specified number, generates a key question sentence for asking a user a question. The key question sentence generation unit 110 selects a key that meets specified conditions among the keys stored in the answer database 112, and generates a key question sentence that contains this key.

The auxiliary information storage unit 111 is a part that stores ask-back history records in response to input (input sentence, intention information, control information) by a user, and it manages and stores input from a user and an ask-back sentence corresponding to the input (a key constituting a key question sentence, an intention in response to the key, and an acquired key) in chronological order. The acquired key is an initial key obtained from an input sentence and a key used for the subsequent refinement processing. The auxiliary information storage unit 111 accumulates the acquired key as auxiliary information in accordance with the ask-back processing.

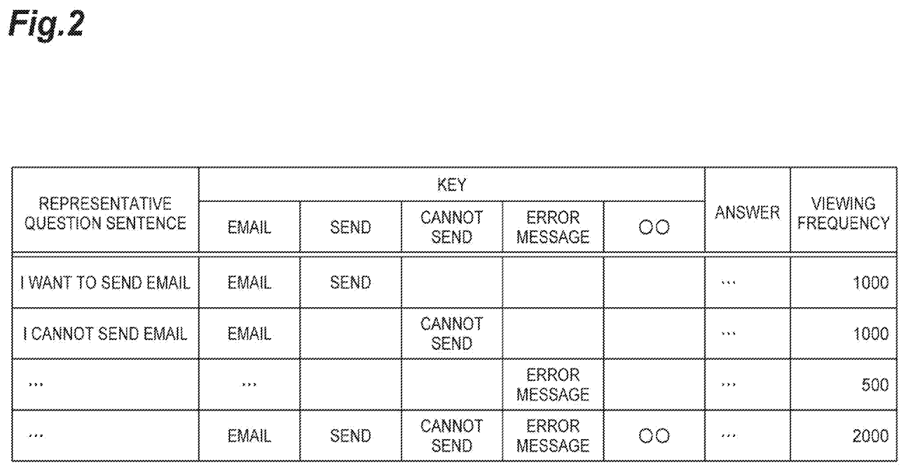

The answer database 112 is a part that stores answer information where a representative question sentence, an answer to the representative question sentence, a key (word) constituting the representative question sentence, and the viewing frequency are associated with one another. FIG. 2 shows a specific example of the answer database 112. As shown in FIG. 2, a key is a word extracted by carrying out morphological analysis of a representative question sentence in advance. The viewing frequency is the frequency of viewing by a user, and it is updated each time viewed. The answer is information registered in advance by an FAQ system administrator in this embodiment.

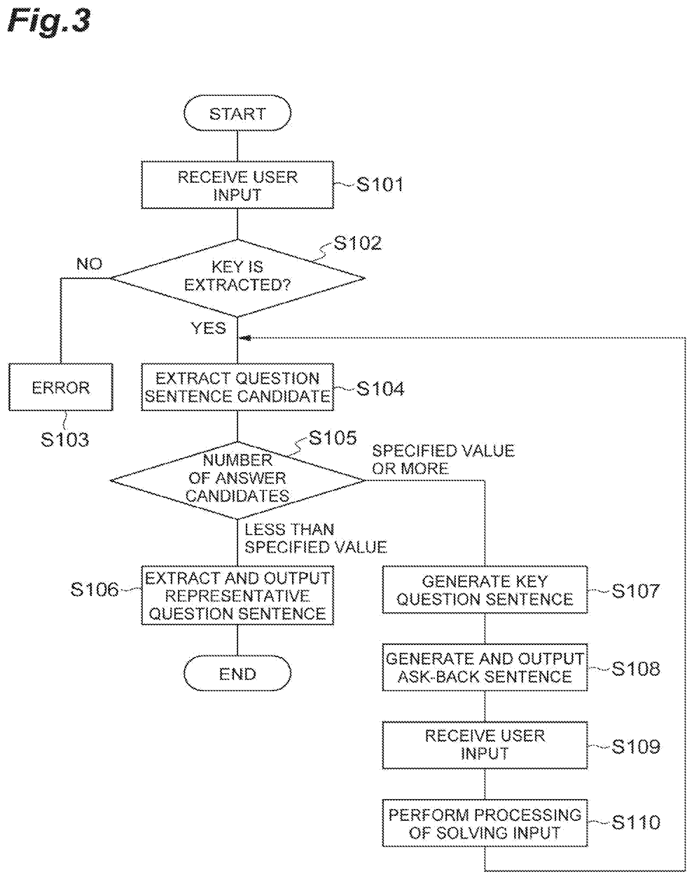

A process performed in the dialogue system having the above-described configuration is described hereinafter. FIG. 3 is a flowchart showing a process of the dialogue server 100 in the dialogue system.

First, the input unit 101 receives an input sentence from the user terminal 200 (S101), and the key extraction unit 106 extracts an initial key based on the input sentence. When the key extraction unit 106 determines that it has failed to extract an initial key (No in S102), the output unit 105 transmits an error notification to the user terminal 200 (S103).

When, on the other hand, the key extraction unit 106 determines that it has extracted an initial key (Yes in S102), the candidate refinement unit 103 performs refinement by extracting one or a plurality of question sentence candidate information from the answer database 112 based on the extracted initial key (S104).

When the candidate refinement unit 103 determines that the number of extracted question sentence candidate information is less than a specified value (“Less than specified value” in S105), the ask-back sentence generation unit 104 extracts a representative question sentence from the extracted question sentence candidate information, and the output unit 105 transmits the representative question sentence as a refinement result to the user terminal 200 (S106). After that, a user operates the user terminal 200 to give an answer instruction based on the representative question sentence and thereby obtains an answer to the representative question sentence.

On the other hand, in Step S105, when the candidate refinement unit 103 determines that the number of question sentence candidate information is more than a specified value (“Specified value or more” in S105), the key question sentence generation unit 110 generates a key question sentence that contains one key other than the initial key (S107). A process of generating the key question sentence is as follows.

For example, by referring to the answer database 112, the key question sentence generation unit 110 further extracts one key for generating a key question sentence from the question sentence candidate information containing the initial key extracted in Step S102. A criterion for selecting this one key is selecting a representative question sentence associated with an answer with high viewing frequency and selecting a key associated with this representative question sentence. When a plurality of keys, in addition to the initial key, are associated with the selected representative question sentence, the key question sentence generation unit 110 selects a key where the number of question sentence candidate information is large. Alternatively, a key in a predetermined part of speech may be selected. In the case of an FAQ system, a verb may be selected because only a noun is likely to be input as an input sentence. Further alternatively, a key may be selected based on predetermined priorities of keys. Note that a selection criterion is not limited thereto.

After the key question sentence generation unit 110 generates the key question sentence, the ask-back sentence generation unit 104 extracts the acquired key from the auxiliary information storage unit 111, and generates an ask-back sentence (output) that contains the key question sentence and the acquired key (S108). The key question sentence contained in the ask-back sentence prompts a user to clearly express an intention of affirmation or negation for one key that constitutes this key question sentence.

The input unit 101 receives a refinement instruction (affirmative intention or negative intention) for the ask-back sentence (key question sentence) transmitted to the user terminal 200 in Step S108 (S109), and the input solving unit 102 performs processing of solving input in accordance with the refinement instruction (S110). After the processing of solving input is done, the process returns to S104 to perform processing of refining question sentence candidates, and it is repeated until the number of representative question sentences falls below a specified value.

The processing of solving input in Step S110 is described in further detail below. When the input solving unit 102 receives intention information of affirmation or negation from the user terminal 200 in response to the key question sentence contained in the ask-back sentence, it outputs the intention information to the intention recognition unit 107, and the intention recognition unit 107 performs processing of recognizing an intention in accordance with the intention information. To be specific, when the intention information indicates affirmation for one key contained in the key question sentence, the intention recognition unit 107 stores the one key contained in the key question sentence as the acquired key into the auxiliary information storage unit 111.

On the other hand, when the intention information indicates negation, the intention recognition unit 107 does not treat the one key contained in the key question sentence as the acquired key, and performs processing for excluding the representative question sentence associated with this denied key from the question sentence candidate information. For example, the intention recognition unit 107 stores the fact that this one key is denied into the auxiliary information storage unit 111.

Further, when the input solving unit 102 receives skip processing, undo processing or clear processing for the key question sentence from the user terminal 200, it requests the control information processing unit 108 to perform this processing. For example, when a request for skip processing is received, the control information processing unit 108 refrains from storing the key described in the key question sentence as the acquired key into the auxiliary information storage unit 111, and stores the fact that this key is skipped into the auxiliary information storage unit 111. When the input solving unit 102 receives a request for undo processing, the control information processing unit 108 refrains from storing the key described in the key question sentence as the acquired key into the auxiliary information storage unit 111, and performs processing for generating the immediately previous key question sentence. When the input solving unit 102 receives a request for clear processing, the control information processing unit 108 performs processing to return to the initial state of input.

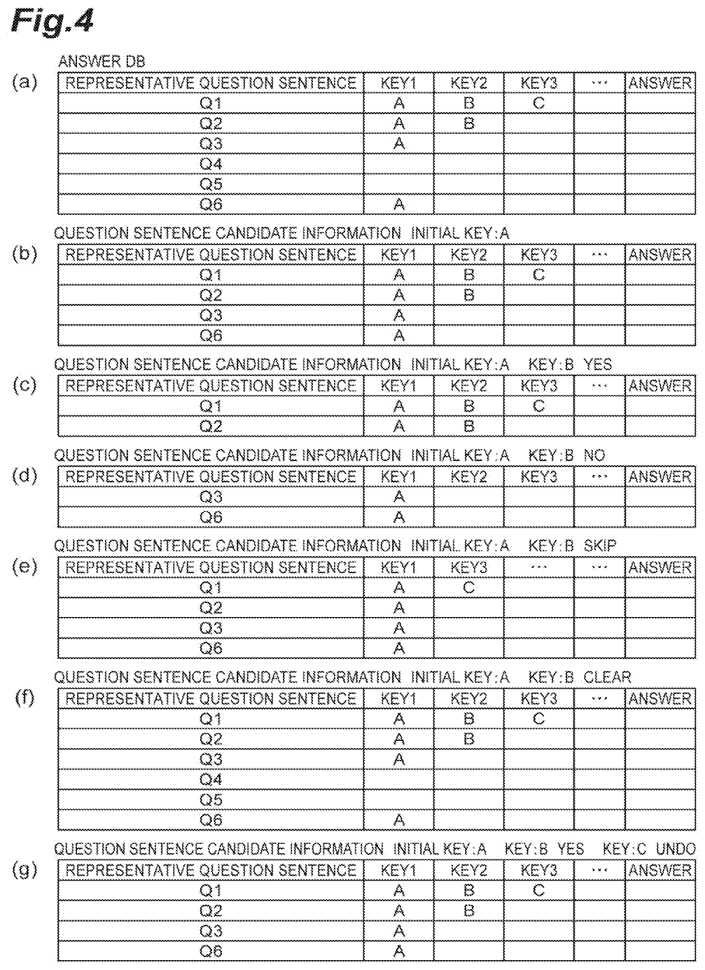

The above-described processing of solving input is described with reference to a specific example. FIG. 4 is a view schematically showing the answer database 112 and question sentence candidate information corresponding to each processing. FIG. 4(a) shows answer information stored in the answer database 112. The illustration thereof is simplified in FIG. 4, which shows a schematic view. In this example, the answer information where representative question sentences Q1 to Q6, keys 1 to 3, and answer sentence are associated with one another is shown.

FIG. 4(b) shows question sentence candidate information refined with the initial key “A”. The answer information stored in the answer database 112 is narrowed down to the question sentence candidate information containing the key “A”.

FIG. 4(c) shows question sentence candidate information when intention information indicating affirmation is received in response to the key question sentence containing the key “B”, after the question sentence candidate information refined with the initial key “A”. The question sentence candidate information refined with the initial key “A” is further narrowed down to the question sentence candidate information containing the key “B”.

FIG. 4(d) shows question sentence candidate information when intention information indicating negation is received in response to the key question sentence containing the key “B”, after the question sentence candidate information refined with the initial key “A”. Because the key “B” is denied, the question sentence candidate information containing the key “B” is excluded from the question sentence candidate information refined with the initial key “A”.

FIG. 4(e) shows question sentence candidate information when control information indicating skip processing is received in response to the key question sentence containing the key “B”, after the question sentence candidate information refined with the initial key “A”. Because an instruction for the key “B” is skipped, the question sentence candidate information remains unchanged. On the other hand, the key “B” of the skipped key question sentence is excluded from the question sentence candidate information in order to avoid being selected. Alternatively, the priority of the question sentence candidate information with the key “B” may be changed in such a way that it is selected last.

FIG. 4(f) shows question sentence candidate information when control information indicating clear processing is received in response to the key question sentence containing the key “B”, after the question sentence candidate information refined with the initial key “A”. In this case, the refinement on the basis of the initial key “A” is cleared, and all of the answer information originally stored in the answer database 112 become the question sentence candidate information.

FIG. 4(g) shows question sentence candidate information when control information indicating an affirmative intention to the initial key “A” and the key “B” and further indicating undo processing in response to the key question sentence containing the key “C” is received. Because it returns to immediately previous processing, it returns to the state where the key “B” is neither confirmed nor denied as the question sentence candidate information.

The auxiliary information storage unit 111 may store the intention information or the control information for one key in association as an input history record according to the chronological order of dialogue processing, and the control information processing unit 108 may perform undo processing or clear processing based on those input history records.

Further, the auxiliary information storage unit 111 may store each of all the states of those refined question sentence candidate information. Then, the control information processing unit 108 may acquire, from the auxiliary information storage unit 111, the question sentence candidate information in the state corresponding to an instruction of undo processing or clear processing.

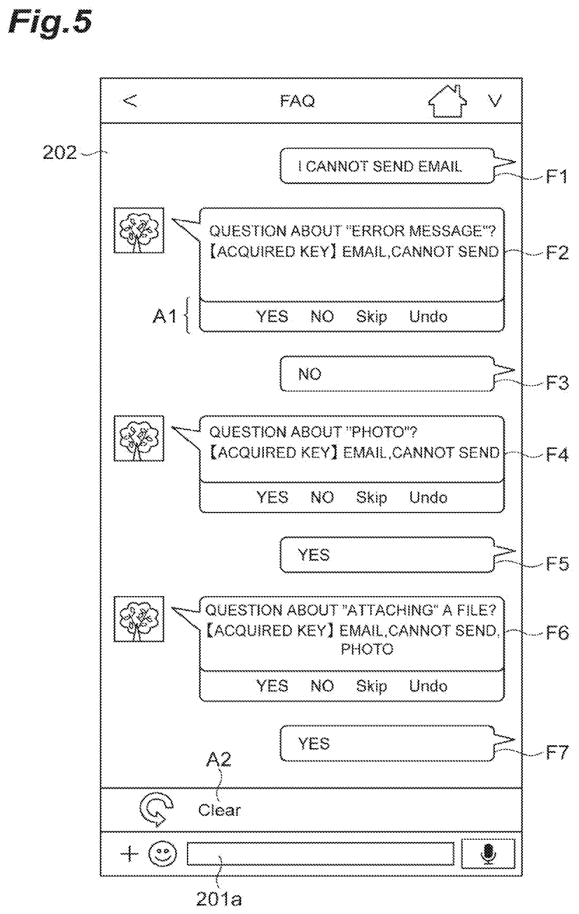

A. display screen that is displayed on the user terminal 200 in the dialogue system according to this embodiment is described hereinafter. FIG. 5 is a view showing a display screen of the user terminal 200. The user terminal 200 with a touch panel display is described in this example. Thus, the display unit 202 serves as the user input unit 201, and a user can input and select information by tapping on an icon or the like displayed on the display unit 202. An input window 201a is a part that receives character input by a touch panel. Speech balloons F1 to F7 are parts indicating dialogue between a user and the dialogue system. Icons A1 and A2 are parts that receive input of the intention information and the control information and, by tapping on each icon, a user can clearly indicate an intention or give a control instruction in accordance with each function.

As shown in FIG. 5, the speech balloons F1, F3, F5 and F7 show an input sequence and a clear indication of an intention input by a user's input operation or selection operation on the user terminal 200. The speech balloons F2, F4 and F6 show an ask-back sentence that contains a key question sentence generated in the dialogue server 100 in response to an input sentence input by a user and an acquired key.

For example, when the input sentence shown in the speech balloon F1 is input in the user terminal 200, the ask-back sentence generation unit 104 in the dialogue server 100 generates the ask-back sentence shown in the speech balloon F2 in response to the input sentence, and the output unit 105 outputs the ask-back sentence shown in the speech balloon F2 to the user terminal 200.

This ask-hack sentence is generated by the following process. First, in the dialogue server 100, the key extraction unit 106 extracts the two words “email” and “cannot send” as the initial keys.

The candidate refinement unit 103 refines the question sentence candidate information based on the initial keys from the answer information stored in the answer database 112. Then, the ask-back sentence generation unit 104 extracts one key for generating a key question sentence from the refined question sentence candidate information by referring to the answer database 112. One key is selected based on the viewing frequency or the like as described above. Then, the key question sentence generation unit 110 generates a key question sentence containing one key, and further the ask-back sentence generation unit 104 extracts an acquired key from the auxiliary information storage unit 111 and generates an ask-back sentence containing the acquired key and the key question sentence.

In the example of FIG. 5, the key question sentence generation unit 110 generates a key question sentence containing “error message” as one key. Then, the ask-back sentence generation unit 104 generates an ask-back sentence containing “email” and “cannot send”, which are extracted as the acquired key, and the output unit 105 outputs this ask-back sentence to the user terminal

The user terminal 200 receives the ask-back sentence shown in the speech balloon F2, and the display unit 202 displays this ask-back sentence together with the icon A1, which is prepared in advance. Then, the user performs any of tapping on (selecting) the icon A1 (any of Yes, No, Skip and Undo), tapping on the icon A2 “Clear”, and inputting a new key to the input window 201a.

In this example, the user taps on “No”, and the display unit 202 displays the speech balloon F3. The user terminal 200 then transmits a notification of this fact (“error message” is denied) to the dialogue server 100. In the dialogue server 100, the ask-back sentence generation unit 104 generates an ask-back sentence shown in the speech balloon F4, and the output unit 105 transmits this ask-back sentence to the user terminal 200. In the user terminal 200, the display unit 202 displays the speech balloon F4.

Because the user has tapped on “No” for “error message” described in the speech balloon F2, the candidate refinement unit 103 in the dialogue server 100 refrains from selecting “error message” as the acquired key, and refines the question sentence candidate information excluding this key. Then, the key question sentence generation unit 110 extracts one key for generating the next key question sentence from the refined question sentence candidate information. In this example, the key question sentence generation unit 110 extracts “photo” and generates a key question sentence containing the key “photo”. Further, the ask-back sentence generation unit 104 selects “email” and “cannot send” as the acquired key, and generates an ask-back sentence containing those information. Note that, the intention recognition unit 107 does not select “error message” as the acquired key because the user has tapped on “No”.

Then, the user taps on “Yes” for the ask-back sentence shown in the speech balloon F4, and the display unit 202 displays the speech balloon F5. The user terminal 200 then transmits a notification of this fact (“photo” is confirmed) to the dialogue server 100. The dialogue server 100 generates an ask-back sentence shown in the speech balloon F6 and transmits it to the user terminal 200. In the user terminal 200, the display unit 202 displays the speech balloon F6.

Specifically, when the user taps on “Yes” for “photo” described in the speech balloon F4, the candidate refinement unit 103 in the dialogue server 100 selects “photo” as the acquired key, and refines the question sentence candidate information including this key. Then, the ask-back sentence generation unit 104 extracts one key for generating the next key question sentence from the refined question sentence candidate information. In this example, the key question sentence generation unit 110 extracts “attaching” and generates a key question sentence containing it. Further, the ask-back sentence generation unit 104 selects “photo” as the acquired key in addition to “email” and “cannot send”, and generates an ask-back sentence containing those information. The ask-back sentence in the speech balloon F6 is thereby generated.

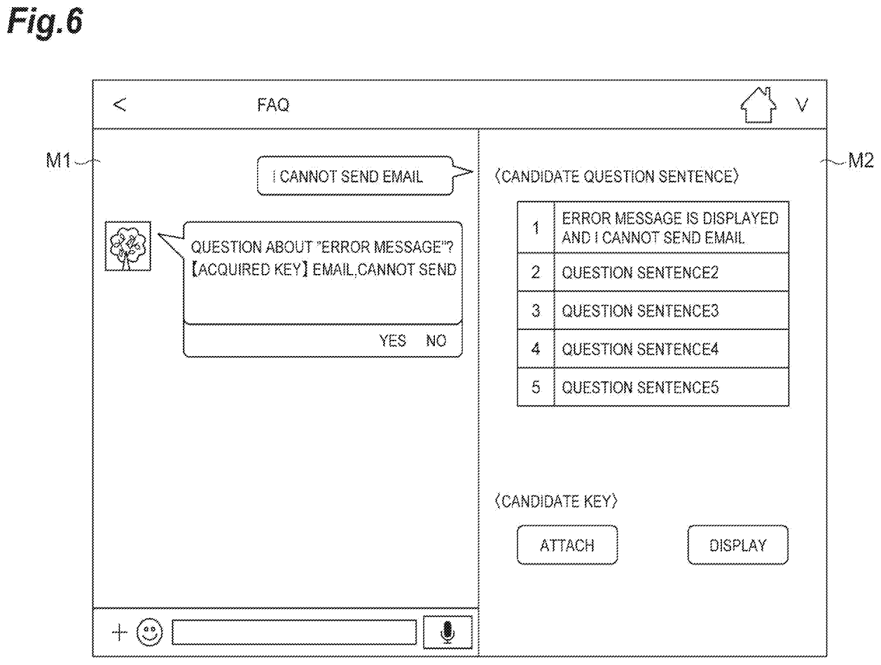

An alternative example of the display screen that is displayed on the display unit 202 of the user terminal 200 is described hereinbelow. In this alternative example, the display screen has an auxiliary screen M2 in addition to a dialogue screen M1. FIG. 6 is a view showing the display screen that includes the dialogue screen M1 and the auxiliary screen M2. As shown in FIG. 6, the dialogue screen M1 shows the progress of dialogue between the user terminal 200 (user) and the dialogue server 100, and the auxiliary screen M2 shows candidate question sentences to be used when a user makes selection in response to an ask-back sentence. The candidate question sentences are candidates for a representative question sentence which a user desires to ask, and they are a plurality of candidates for a representative question sentence to be used when a user gives an instruction in response to an ask-back sentence and when a user initially enters an input sequence.

Further, the auxiliary screen M2 contains a candidate key. The candidate key is a key that is likely to be contained in the next key question sentence. A user can know the content of the next key question sentence from the candidate key. In the auxiliary screen M2, “attach” and “display” are shown as the candidate key, and a user can thereby know the keys to be asked back next.

Extraction of the candidate key is as follows. When generating a key question sentence, the key question sentence generation unit 110 extracts one key from the answer database 112. In addition to one key to be contained in the key question sentence, the key question sentence generation unit 110 also extracts a key to be extracted when this one key is confirmed and a key to be extracted when this one key is denied. Those keys are output as the candidate key to the user terminal 200. Note that another key may be also extracted as the candidate key.

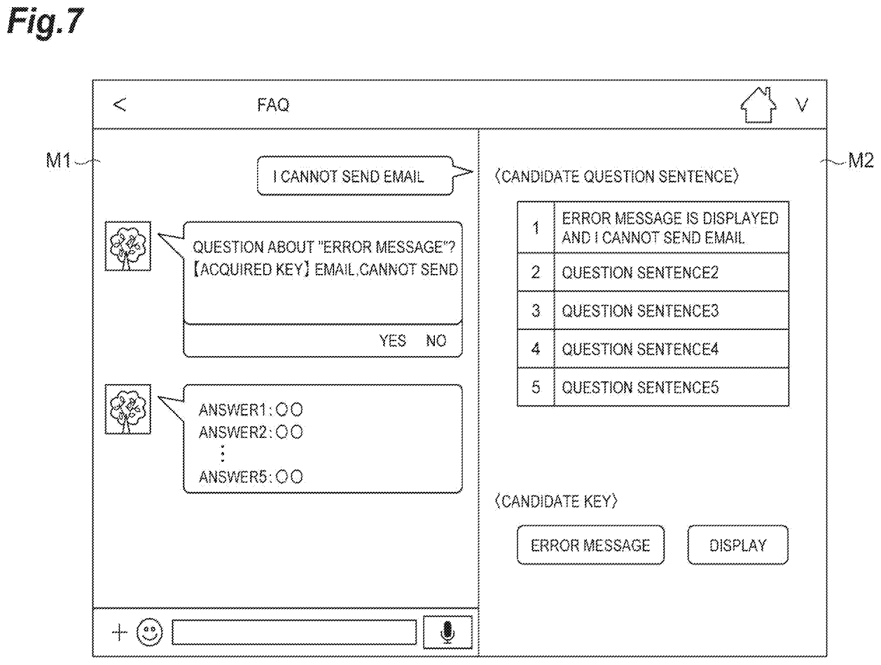

FIG. 7 is a view showing displaying answers corresponding to candidate question sentences on the dialogue screen M1. As shown in FIG. 7, candidate question sentences are displayed on the auxiliary screen M2, and the transition of dialogue is displayed on the dialogue screen M1. In this example, a list of answers in response to the candidate question sentences is further displayed on the dialogue screen M1, so that a user can more quickly obtain an answer.

Specifically, the representative question sentence extraction unit 109 extracts representative question sentences and their answers refined by the candidate refinement unit 103 from the answer database 112, and use them as the candidate question sentences and their answers. The ask-back sentence generation unit 104 generates an ask-back sentence where each candidate question sentence and its answer are associated with each other, and the output unit 105 outputs this ask-back sentence. The user terminal 200 displays the output ask-back sentence as shown in FIG. 7.

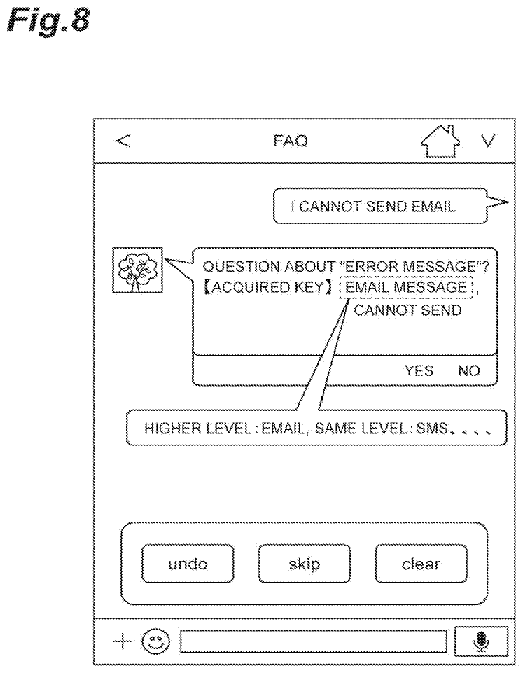

FIG. 8 is a view showing a display screen when editing an acquired key. As shown in FIG. 8, a user taps on (selects) “email” displayed as the acquired key, and thereby the display unit 202 displays another key (related key) associated with “email” for selection. In this example, the display unit 202 displays “SMS” and “email message”. A user selects a related key associated with one acquired key, and thereby the user terminal 200 specifies the acquired key to replace the acquired key, and transmits an instruction for replacement to the dialogue server 100.

The control information processing unit. 108 of the dialogue server 100 receives the instruction for replacing the acquired key from the user terminal 200, and the candidate refinement unit 103 performs processing of re-acquiring question sentence candidate information by using the acquired key including the key (related key) added by replacement. Further, the key question sentence generation unit 110 extracts a key for generating a key question sentence based on the related key. The ask-back sentence generation unit 104 generates an ask-back sentence containing the key question sentence changed according to replacement of the acquired key and the changed acquired key, and the output unit 105 outputs this ask-back sentence to the user terminal 200.

The related key is described hereinafter. The related key is a key that is related to a key to be replaced, and it is a synonym, a superordinate concept or a subordinate concept of the key to be replaced. For example, the answer database 112 stores information indicating that keys are replaceable, information indicating that keys are in a superordinate-subordinate relationship or the like. Then, when a user selects an instruction for replacement of an acquired key in the user terminal 200, the control information processing unit 108 in the dialogue server 100 extracts, from the answer database 112, one or a plurality of related keys corresponding to the acquired key to be replaced in accordance with the instruction for replacement (the acquired key to be replaced) transmitted from the user terminal 200.

Then, the output unit 105 outputs the one or plurality of related keys in such a way that they are selectable by a user in the user terminal 200. The user selects one related key from the one or plurality of related keys and thereby gives an instruction to replace the acquired key. Note that the related key may be displayed showing whether it is in a higher level (superordinate concept), the same level (synonym) or a lower level (subordinate concept).

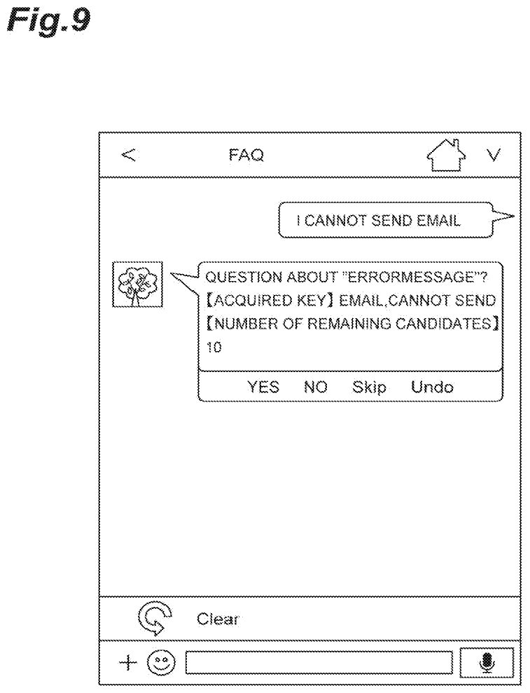

As another alternative example, as shown in FIG. 9, the ask-back sentence generation unit 104 may generate the content of output where the current number of question sentence candidate information is added to an ask-back sentence. Specifically, when the candidate refinement unit 103 refines question sentence candidate information, it extracts the number of question sentence candidate information and passes the number information to the ask-back sentence generation unit 104. The ask-back sentence generation unit 104 generates an ask-back sentence containing this number information. Further, the ask-back sentence generation unit 104 may generate the content of output where the number of question sentence candidate information when a user selects “Yes” and the number of question sentence candidate information when the user selects “No” can be displayed separately from each other.

Further, as another alternative example, when one answer can be derived from a plurality of question sentences, the answer database 112 may carry out processing for reducing the number of times of asking back by setting the same answer ID. Specifically, in the answer database 112, the same ID is assigned to the representative question sentences associated with the same answer. Then, when refining the representative question sentences by using the initial key and one key, the candidate refinement unit 103 can leave only one arbitrary representative question sentence for the representative question sentences to which the same ID is assigned, and excludes the other representative question sentences from the refined sentences. It is thereby possible to reduce the number of times of asking back.

The operational advantage of a dialogue system 10 configured as above is described hereinafter. The dialogue system 10 according to this embodiment is a system that provides an answer in response to input by a user. The answer database 112 stores answer information in which a representative question sentence, a group of keys including one or a plurality of keys constituting the representative question sentence, and an answer to the representative question sentence are associated with one another.

The input unit 101 inputs an input sentence transmitted from the user terminal 200, and the input solving unit 102 extracts one or a plurality of initial keys based on the input sentence in cooperation with the key extraction unit 106. Next, the candidate refinement unit 103 refines the representative question sentences stored in the answer database 112 based on the initial key extracted by the key extraction unit 106.

The key question sentence generation unit 110 extracts one key from the answer database 112 based on the one or plurality of initial keys, and generates a key question sentence. Then, the ask-back sentence generation unit 104 generates an ask-back sentence containing the generated key question sentence and the acquired key. The output unit 105 transmits the ask-back sentence containing the key question sentence containing the one key and the one or plurality of initial keys to the user terminal 200.

Further, the output unit 105 transmits the one or plurality of initial keys as the acquired key used for extracting the one key to the user terminal 200, and transmits a key question sentence that prompts a user to clearly express an intention for the one key to the user terminal 200. By such processing, dialogue processing is performed by input of a key and an ask-back sentence in response to it.

The candidate refinement unit 103 refines the representative question sentences based on a user's intention answered in response to a key question sentence, and when a specified condition (e.g., the number of candidates is less than a specified value) is satisfied, the output unit 105 transmits the representative question sentences refined by the candidate refinement unit 103 to the user terminal.

In this configuration, a user can gradually refine a question sentence even when the user does not come up with a key (keyword) for searching question sentences or remembers a wrong key. The user can thereby easily acquire an appropriate question sentence, and it is possible to provide a dialogue system offering smooth FAQ for a user.

On the other hand, the dialogue system 10 can provide an appropriate question sentence to a user and can thereby reduce the number of times of providing a question sentence. It is thereby possible to reduce processing loads on a control unit (processor 1001) such as a CPU in the dialogue system 10. It is also possible to achieve efficient communication and reduce network loads.

Further, a user can know an acquired key used for extracting one key, and thereby know what has been recognized for asking back, and it is thereby possible to presume what question sentence will be asked next.

Note that, although the dialogue system 10 includes the dialogue server 100 and the user terminal 200 in the above-described embodiment, it is not limited thereto. The user terminal 200 may have the same function as the dialogue server 100 and the user terminal 200 may constitute the dialogue system 10, or the user terminal 200 may have some of the functions of the dialogue server 100.

Further, in the dialogue system according to this embodiment, when an affirmative intention indicating confirmation is expressed for a key question sentence containing one key presented to a user, the input solving unit 102 extracts a first key, which is another key associated with the initial key and the one key in the answer database 112, from the answer database 112 in accordance with this affirmative intention in cooperation with the intention recognition unit 107.

The key question sentence generation unit 110 generates a key question sentence that prompts a user to clearly express an intention of affirmation or negation for the first key. Then, the ask-back sentence generation unit 104 generates an ask-back sentence containing the key question sentence where the one key is presented to a user as the acquired key used for extracting the first key. The output unit 105 outputs the generated ask-back sentence.

In this configuration, when a user answers an affirmative response to one key in a key question sentence, the user can receive a key question sentence containing a first key based on the one key. Thus, a user can gradually refine a question sentence even when the user does not come up with a key or remembers a wrong key.

Further, in the dialogue system 10 according to this embodiment, when a negative intention indicating denial is expressed for a key question sentence containing one key presented to a user, the input solving unit 102 extracts a second key, which is another key associated with the initial key and not associated with the one key in the answer database 112, from the answer database 112 in accordance with this negative intention in cooperation with the intention recognition unit 107.

The key question sentence generation unit 110 generates a key question sentence that prompts a user to clearly express an intention of affirmation or negation for the second key. Then, the ask-back sentence generation unit 104 generates an ask-back sentence containing the key question sentence where the one key is presented to a user as the acquired key used for extracting the second key. The output unit 105 outputs the generated ask-back sentence.

In this configuration, when a user answers a negative response to one key in a key question sentence, the user can receive a key question sentence containing a second key among representative question sentences excluding the one key. Thus, a user can gradually refine a question sentence even when the user does not come up with a key or remembers a wrong key.

Further, in the dialogue system 10 according to this embodiment, the key question sentence generation unit 110 extracts another key that is associated with one key and that is likely to be presented next from the answer database 112 based on the initial key.

The ask-back sentence generation unit 104 generates an ask-back sentence, and the output unit 105 outputs the another key as the candidate key, together with the ask-back sentence containing the one key and the one or plurality of initial keys, to the user terminal 200.

In this configuration, a user can know in advance what key will be asked back next and can thereby easily grasp the state of dialogue processing.

Further, in the dialogue system 10 according to this embodiment, the control information processing unit 108 replaces an acquired key with a related key associated with the acquired key in the answer database 112 in accordance with a user's operation, and the candidate refinement unit 103 refines the representative question sentences by using the related key added by replacement.

In this configuration, when an unintended key is extracted, it is possible to edit the key. A user can thereby easily find an intended question sentence.

Further, the dialogue system 10 according to this embodiment includes the control information processing unit 108 that performs at least one of skip processing that skips a key question sentence without expressing any intention and moves on to the next key question sentence, undo processing that returns to a key question sentence presented before the current question sentence, and clear processing that clears all of key question sentences in accordance with a user's operation.

When the control information processing unit 108 determines that skip processing is selected when a key question sentence containing one key is presented to a user, the candidate refinement unit 103 refrains from performing refinement processing, and the key question sentence generation unit 110 performs processing for skip processing. Specifically, the key question sentence generation unit 110 does not add one key of the skipped key question sentence to the acquired key, and acquires a third key, which is another key associated with the acquired key used for acquiring the one key contained in the skipped key question sentence in the answer database 112. Then, the key question sentence generation unit 110 generates a key question sentence containing the third key, and the output unit 105 transmits an ask-back sentence containing this key question sentence to the user terminal 200.

Further, when the control information processing unit 108 determines that undo processing is selected when a key question sentence containing another key is presented to a user after clearly expressing an intention in response to a key question sentence containing one key, the key question sentence generation unit 110 generates a key question sentence containing the one key again, and the output unit 105 outputs an ask-back sentence containing this key question sentence.

Further, when the control information processing unit 108 determines that clear processing is selected, it performs processing of waiting for input of an initial key. The output unit 105 outputs information for waiting for input to the user terminal 200.

In this configuration, it is possible to carry out skipping or returning in dialogue processing when a wrong answer is entered or a key that is hard to be answered is asked, for example. A user can thereby easily find an intended question sentence.

The block diagram used in the description of the above embodiment shows the block of each functional unit. Those functional blocks (component parts) are implemented by any combination of hardware and/or software. Further, a means of implementing each functional block is not particularly limited. Specifically, each functional block may be implemented by one physically and/or logically combined device or may be implemented by two or more physically and/or logically separated devices that are directly and/or indirectly connected (e.g., wired and/or wireless connections).

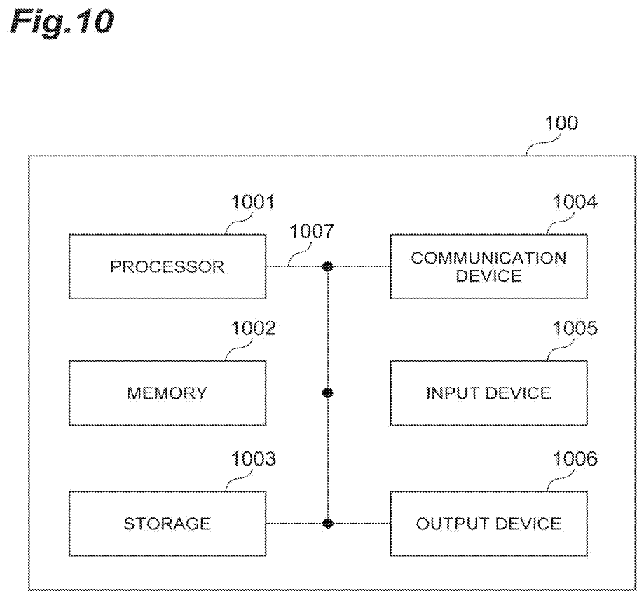

For example, the dialogue server 100, the user terminal 200 and the like in one embodiment of the present invention may function as a computer that performs processing of the dialogue server 100 and the user terminal 200 in this embodiment. FIG. 10 is a view showing an example of the hardware configuration of the dialogue server 100 and the user terminal 200 according to this embodiment. The dialogue server 100 and the user terminal 200 described above may be physically configured as a computer device including a processor 1001, a memory 1002, a storage 1003, a communication device 1004, an input device 1005, an output device 1006, a bus 1007 and the like.

In the following description, the term “device” may be replaced with a circuit, a device, a unit or the like. The hardware configuration of the dialogue server 100 and the user terminal 200 may be configured to include one or a plurality of the above-described devices or may be configured without including some of the devices.

The functions of the dialogue server 100 and the user terminal 200 may be implemented by allowing predetermined software (programs) to be loaded on the hardware such as the processor 1001, the memory 1002 and the like so as to cause the processor 1001 to perform computations to control communications by the communication device 1004, and reading and/or writing of data in the memory 1002 and the storage 1003.

The processor 1001 may, for example, operate an operating system to control the entire computer. The processor 1001 may be configured to include a CPU (Central Processing Unit) including an interface with a peripheral device, a control device, an arithmetic device, a register and the like. For example, the input solving unit 102, the candidate refinement unit 103 and the like may be implemented by the processor 1001.

Further, the processor 1001 loads a program (program code), a software module and data from the storage 1003 and/or the communication device 1004 into the memory 1002 and performs various processing according to them. As the program, a program that causes a computer to execute at least some of the operations described in the above embodiment is used. For example, the dialogue server 100, the input solving unit 102 of the user terminal 200 or the like may be implemented by a control program that is stored in the memory 1002 and operates on the processor 1001, and another functional block may be implemented in the same manner. Although the above-described processing is executed by one processor 1001 in the above description, the processing may be executed simultaneously or sequentially by two or more processors 1001. The processor 1001 may be implemented in one or more chips. Note that the program may be transmitted from a network through a telecommunications line.

The memory 1002 may be a computer-readable recording medium, and it may be composed of at least one of ROM (Read Only Memory), EPROM (Erasable Programmable ROM), EEPROM (Electrically Erasable Programmable ROM), RAM (Random Access Memory) and the like, for example. The memory 1002 may be also called a register, a cache, a main memory (main storage device) or the like. The memory 1002 can store a program (program code), a software module and the like that can be executed for implementing a radio communication method according to one embodiment of the present invention.

The storage 1003 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage 1003 may be referred to as an auxiliary storage device. The above-described storage medium may be a database, a server, or another appropriate medium including the memory 1002 and/or the storage1003, for example.

The communication device 1004 is hardware (a transmitting and receiving device) for performing communication between computers via a wired and/or wireless network, and it may also be referred to as a network device, a network controller, a network card, a communication module, or the like. For example, the input unit 101, the output unit 105 and the like described above may be implemented by the communication device1004.

The input device 1005 is an input device (e.g., a keyboard, a mouse, a microphone, a switch, a button, and a sensor) that receives an input from the outside. The output device 1006 is an output device (e.g., a display, a speaker, and an LED lamp) that generates an output to the outside. Note that the input device 1005 and the output device 1006 may be integrated (e.g., a touch panel).

In addition, the devices such as the processor 1001 and the memory 1002 are connected by the bus 1007 for communicating information. The bus 1007 may be a single bus or may be composed of different buses between different devices.

Further, the dialogue server 100 and the user terminal 200 may include hardware such as a microprocessor, a DSP (Digital Signal Processor), an ASIC (Application Specific Integrated Circuit), a PLD (Programmable Logic Device), and an FPGA (Field Programmable Gate Array), or some or all of the functional blocks may be implemented by the above-described hardware components. For example, the processor 1001 may be implemented with at least one of these hardware components.

In the above description, it is apparent to those skilled in the art that the present invention is not restricted to the embodiment described in this specification. The present invention can be implemented as a modified and changed form without deviating from the spirit and scope of the present invention defined by the appended claims. Accordingly, the description of the present specification is given merely by way of illustration and does not have any restrictive meaning to the present invention,

Further, each aspect/embodiment described in the present specification may be applied to LTE (Long Term Evolution), LTE-A (LTE Advanced), SUPER 3G, IMT-Advanced, 4G, 5G, FRA (Future Radio Access), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra Wide Band), Bluetooth (registered trademark), a system using another appropriate system and/or a next generation system extended based on these systems.

The procedure, the sequence, the flowchart and the like in each aspect/embodiment described in this specification may be in a different order unless inconsistency arises. For example, for the method described in this specification, elements of various steps are described in an exemplified order, and it is not limited to the specific order described above.

Input/output information or the like may be stored in a specific location (e.g., memory) or managed in a management table. Further, input/output information or the like can be overwritten or updated, or additional data can be written. Output information or the like may be deleted. Input information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each aspect/embodiment described in the present specification may be used alone, may be used in combination, or may be used by being switched according to the execution. Further, a notification of specified information (e.g., a notification of “being X”) is not limited to be made explicitly, and it may be made implicitly (e.g., a notification of the specified information is not made).

Software may be called any of software, firmware, middleware, microcode, hardware description language or another name, and it should be should be interpreted widely so as to mean an instruction, an instruction set, a code, a code segment, a program code, a program, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using wired technology such as a coaxial cable, an optical fiber cable, a twisted pair and a digital subscriber line (DSL) and/or wireless technology such as infrared rays, radio and microwaves, those wired technology and/or wireless technology are included in the definition of the transmission medium.

The information, signals and the like described in the present specification may be represented by any of various different technologies. For example, data, an instruction, a command, information, a signal, a bit, a symbol, a chip and the like that can he referred to in the above description may be represented by a voltage, a current, an electromagnetic wave, a magnetic field or a magnetic particle, an optical field or a photon, or an arbitrary combination of them.

Note that the term described in the present specification and/or the term needed to understand the present specification may be replaced by a term having the same or similar meaning.

The terms “system” and “network” used in the present specification are used to be compatible with each other.

Further, information, parameters and the like described in the present specification may be represented by an absolute value, a relative value to a specified value, or corresponding different information. For example, radio resources may be indicated by an index.

The mobile station can be also called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or several other appropriate terms.

Note that the term “determining” and “determining” used in the present specification includes a variety of operations. For example, “determining” and “determining” can include regarding the act of judging, calculating, computing, processing, deriving, investigating, looking up (e.g., looking up in a table, a database or another data structure), ascertaining or the like as being “determined” and “determined”. Further, “determining” and “determining” can include regarding the act of receiving (e.g., receiving information), transmitting (e.g., transmitting information), input, output, accessing (e.g., accessing data in a memory) or the like as being “determined” and “determined”. Further, “determining” and “determining” can include regarding the act of resolving, selecting, choosing, establishing, comparing or the like as being “determined” and “determined”. In other words, “determining” and “determining” can include regarding a certain operation as being “determined” and “determined”.

Further, the description “based on” used in the present specification does not mean “based only on” unless otherwise noted. In other words, the description “based on” means both of “based only on” and “based at least on”.

When the terms such as “first” and “second” are used in this specification, any reference to the element does not limit the amount or order of the elements in general. Those terms can be used in this specification as a convenient way to distinguish between two or more elements. Thus, reference to the first and second elements does not mean that only two elements can be adopted or the first element needs to precede the second element.

In this specification, reference to a device includes both one and more than one of such devices unless it is obviously singular contextually or technically.

In the entire present disclosure, the singular includes the plural except where otherwise clearly indicated by context.

### REFERENCE SIGNS LIST

10 . . . dialogue system, 100 . . . dialogue server, 101 . . . input unit, 102 . . . input solving unit, 103 . . . candidate refinement unit, 104 . . . ask-back sentence generation unit, 105 . . . output unit, 106 . . . key extraction unit, 107 . . . intention recognition unit, 108 . . . control information processing unit, 109 . . . representative question sentence extraction unit, 110 . . . key question sentence generation unit, 111 . . . auxiliary information storage unit, 200 . . . user terminal, 201 . . . user input unit, 202 . . . display unit

1. A dialogue system that provides an answer in response to input by a user, comprising
circuitry configured to:
store answer information where a representative question sentence, a group of keys including one or a plurality of keys constituting the representative question sentence, and an answer to the representative question sentence are associated with one another;
extract one or a plurality of initial keys based on an input sequence input by the user;
refine a representative question sentence stored based on an initial key extracted;
extract one key from the answer information storage unit based on the one or plurality of initial keys; and
present the one key and the one or plurality of initial keys to the user, wherein
the circuitry enables presenting, to a user, the one or plurality of initial keys as an acquired key used for acquiring the one key, and presents, to the user, a key question sentence prompting the user to clearly express an intention for the one key,
refines the representative question sentence based on the user's intention expressed in response to the key question sentence, and
presents, to the user, a representative question sentence refined.

2. The dialogue system according to claim 1, wherein
when an affirmative intention indicating confirmation is expressed in response to a key question sentence containing one key presented to the user, the circuitry further extracts a first key in accordance with the affirmative intention, the first key being another key associated with the initial key and the one key, and
the circuitry enables presenting, to the user, the one key as an acquired key used for acquiring the first key, and presents, to the user, a key question sentence prompting the user to clearly express an intention of affirmation or negation for the first key.

3. The dialogue system according to claim 1, wherein
when a negative intention indicating denial is expressed in response to a key question sentence containing one key presented to the user, the circuitry further extracts a second key in accordance with the negative intention, the second key being another key associated with the initial key and not associated with the one key, and
the circuitry enables presenting, to the user, the one key as an acquired key used for acquiring the second key, and presents, to the user, a key question sentence prompting the user to clearly express an intention of affirmation or negation for the second key.

4. The dialogue system according to claim 1, wherein
the circuitry further extracts another key associated with the one key and likely to be presented next based on the initial key, and
the circuitry presents, to the user, the another key as a candidate key together with the one key and the one or plurality of initial keys.

5. The dialogue system according to claim 1, wherein
the circuitry extracts one or a plurality of representative question sentences associated with a key serving as the acquired key, and
the circuitry presents the one or plurality of representative question sentences as a candidate question sentence each time presenting the key question sentence.

6. The dialogue system according to claim 1, the circuitry configured to:
replace the acquired key with a related key associated with the acquired key in the answer information storage unit in accordance with a user's operation, wherein
the circuitry refines the representative question sentence by using the edited related key.

7. The dialogue system according to claim 1, the circuitry is further configured to:
perform skip processing that skips the key question sentence without expressing any intention and moves on to a next key question sentence in accordance with a user's operation, wherein
when the skip processing is selected when a key question sentence containing the one key is presented to the user, the circuitry refrains from treating the one key as an acquired key and extracts a third key being another key associated with an acquired key used for acquiring the one key contained in the skipped key question sentence, and presents a key question sentence containing the third key to the user.

8. The dialogue system according to claim 1, wherein the circuitry is further configured to:
perform undo processing that returns to a key question sentence presented before the key question sentence in accordance with a user's operation, wherein
when the undo processing is selected when a key question sentence containing another key is presented to the user after clearly expressing an intention in response to a key question sentence containing the one key, the circuitry presents a key question sentence containing the one key again.

9. The dialogue system according to claim 1, the circuitry is further configured to:
perform clear processing that clears all of key question sentences in accordance with a user's operation, wherein
when the clear processing is selected, the circuitry performs processing of waiting for receipt of an input sequence for an initial key.
